(19) United States
(12) Patent Application Publication
(10) Pub. No.: US 2024/0315921 A1
(43) Pub. Date: Sep. 26, 2024

(54) SYSTEMS AND METHODS FOR HAPTICS AND TOUCHABLE ACTUATORS

(71) Applicant: Artimus Robotics Inc., Boulder, CO (US)

(72) Inventors: Eric Lucas Acome, Longmont, CO (US); Shane Karl Mitchell, Boulder, CO (US); Nicholas Alexander Kellaris, Boulder, CO (US); Timothy G. Morrissey, Boulder, CO (US)

(73) Assignee: Artimus Robotics Inc., Boulder, CO (US)

(21) Appl. No.: 18/427,258

(22) Filed: Jan. 30, 2024

Related U.S. Application Data
(60) Provisional application No. 63/441,952, filed on Jan. 30, 2023.

(51) Int. Cl. A61H 23/04; A61H 9/00; A61H 23/02; F03G 7/06

(52) U.S. Cl. CPC A61H 23/04; A61H 9/0007; A61H 23/02; F03G 7/06112; F03G 7/0665; A61H 2201/165; A61H 2201/169; A61H 2201/5002

(57) ABSTRACT

An actuator system includes a sleeve for accommodating an appendage of a user therein, actuators, and a power source. Each actuator includes a deformable shell defining a pouch including an enclosed internal cavity with a fluid dielectric contained therein, and first and second electrodes disposed over opposing sides of the pouch. The power source provides a voltage between the first and second electrodes. The sleeve includes features for distributing the actuators within the sleeve in a predetermined manner. Application of the voltage produces directional forces on the appendage. In embodiments, the first and second electrodes are disposed over the pouch such that, when the actuator is activated, the fluid dielectric is displaced in a length direction within the pouch, and the features in the sleeve may or may not align the actuators such that the length direction of the actuators are in alignment.

### FEDERALLY SPONSORED RESEARCH AND DEVELOPMENT

This invention was made with government support under Cooperative Agreement Award Number 2136844 awarded by the National Science Foundation. The government has certain rights in the invention.

### REFERENCE TO RELATED APPLICATIONS

The present application claims the benefit of US Provisional Pat. App. No. 63,441,952, filed 2023 Jan. 30 and titled “Systems and Methods for Haptics and Touchable Actuators,” which application is incorporated hereby in its entirety by reference.

### FIELD OF THE INVENTION

The present invention relates to actuators. In particular, but not by way of limitation, the present invention relates to the use of actuators for haptics and touchable applications.

### DESCRIPTION OF RELATED ART

Existing actuator technologies for haptics are generally made from rigid metallic parts and operate well at high frequencies. However, such technologies are unsuited for contact applications for simulating the sensation of touch. Many of the haptic sensations we experience in reality (i.e., embracing someone, feeling the texture of a surface, etc.) occur at much lower frequencies (e.g., less than 60 Hz) compared to the operational frequencies of existing haptics actuators. Additionally, traditional actuators do not efficiently transmit forces to users due to the mechanical mismatch between rigid metal and soft human tissue.

Thus, there is a need for an improved actuators for use in haptics and touchable applications.

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an embodiment, a soft actuator system is configured for simulating movement, sensation, and/or tactile information to a user. The soft actuator system may include, for example, one or more soft actuators configured to safely come into contact with various portions of a human body for therapeutic and wellness applications. In certain aspects, the soft actuator system may be configured for safely providing high voltage signals to the one or more actuators in proximity to the user or electronic devices that may be sensitive to electromagnetic noise.

In an embodiment, an actuator system includes a sleeve for accommodating an appendage of a user therein, actuators, and a power source. Each actuator includes a deformable shell defining a pouch including an enclosed internal cavity with a fluid dielectric contained therein, and first and second electrodes disposed over opposing sides of the pouch. The power source provides a voltage between the first and second electrodes. The sleeve includes features for distributing the actuators within the sleeve in a predetermined manner. Application of the voltage produces directional forces on the appendage. In embodiments, the first and second electrodes are disposed over the pouch such that, when the actuator is activated, the fluid dielectric is displaced in a length direction within the pouch, and the features in the sleeve may or may not align the actuators such that the length direction of the actuators are in alignment.

In an embodiment, an actuator system includes a sleeve for accommodating an appendage of a user therein, a plurality of actuators, and a power source. Each one of the plurality of actuators includes a deformable shell defining a pouch including an enclosed internal cavity, a fluid dielectric contained within the enclosed internal cavity, a first electrode disposed over a first side of the pouch, and a second electrode disposed over a second side of the pouch. The power source is configured for providing a voltage across the enclosed internal cavity between the first and second electrodes of the plurality of actuators. The sleeve includes features for accommodating the plurality of actuators therein, wherein the features in the sleeve are configured for distributing the plurality of actuators within the sleeve in a predetermined manner. Actuation of the plurality of actuators by application of the voltage produces a plurality of directional forces on the appendage contained within the sleeve.

In embodiments, in each one of the plurality of actuators, the pouch has a length and a width, the length being longer than the width, and the first and second electrodes are disposed over the pouch such that, when activated with the voltage applied across the first and second electrodes, the fluid dielectric is displaced in a length direction within the pouch. The features in the sleeve may be further configured for aligning the plurality of actuators such that the length direction of each one of the plurality of actuators is in alignment with the length direction of each other one of the plurality of actuators.

In embodiments the actuator system further includes a controller for controlling the power source. The power source may be configured for individually addressing each one of the plurality of actuators, and the controller may be configured for modulating the power source such that the plurality of actuators are activatable in an activation pattern. In embodiments, the activation pattern includes at least one of a peristaltic motion, a wave motion, and a pumping motion.

In embodiments, in each one of the plurality of actuators, the pouch has a length and a width, the length being longer than the width. Further, in each one of the plurality of actuators, the first and second electrodes are disposed over the pouch such that, when activated with the voltage applied across the first and second electrodes, the fluid dielectric is displaced in a length direction within the pouch. The features in the sleeve may be further configured for aligning the plurality of actuators such that the length direction of at least one of the plurality of actuators is not in alignment with the length direction of at least one other one of the plurality of actuators.

In certain embodiments, the sleeve may be formed of a stretchable material such that the sleeve may be stretched without affecting activation of the plurality of actuators.

In certain embodiments, the actuator system further includes a second deformable shell encapsulating at least one of the plurality of actuators, and an electrically conductive outer layer disposed over at least a portion of the second deformable shell and connected to a ground.

In embodiments, an actuator system includes a plurality of actuators, a power source, and a controller for controlling the power source. Each one of the plurality of actuators may include a deformable shell defining a pouch including an enclosed internal cavity, a fluid dielectric contained within the enclosed internal cavity, a first electrode disposed over a first side of the pouch, and a second electrode disposed over a second side of the pouch. The power source may be configured for providing a voltage across the enclosed internal cavity between the first and second electrodes of the plurality of actuators. In certain embodiments, the controller is configured for monitoring a value of at least one of charge, voltage, capacitance, resistance, and distance between neighboring actuators. The controller may be further configured for adjusting the voltage provided by the power source according to the value so monitored.

In certain embodiments, the power source is configured for individually addressing each one of the plurality of actuators, and the controller is further configured for modulating the power source such that the plurality of actuators are activatable in an activation pattern. In embodiments, the activation pattern includes at least one of a peristaltic motion, a wave motion, and a pumping motion.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIGS. 1A-1D show simplified schematic illustrations of a HASEL actuator, in accordance with embodiments. In particular, FIG. 1A shows a side cross-sectional view of an unactivated HASEL actuator with two pairs of opposing electrodes, in accordance with an embodiment. FIG. 1B shows a side cross-sectional view of the HASEL actuator of FIG. 1A, with a first pair of electrodes activated, in accordance with an embodiment. FIG. 1C shows a side cross-sectional view of the HASEL actuator of FIG. 1A, with a second pair of electrodes activated, in accordance with an embodiment. FIG. 1D shows a top view of the HASEL actuator of FIG. 1A, in accordance with an embodiment.

FIGS. 2A-2C show simplified schematic illustrations of an alternative HASEL actuator with multiple pairs of opposing electrodes, in accordance with embodiments. In particular, FIG. 2A shows a side cross-sectional view of an unactivated HASEL actuator with four pairs of opposing electrodes, in accordance with an embodiment. FIG. 2B shows a side cross-sectional view of the HASEL actuator of FIG. 2A, with first and third pairs of electrodes activated, in accordance with an embodiment. FIG. 2C shows a side cross-sectional view of the HASEL actuator of FIG. 2A, with first and fourth pairs of electrodes activated, in accordance with an embodiment.

FIGS. 3A-3D show simplified schematic illustrations of a HASEL actuator system configured to provide a peristaltic wave actuation motion, in accordance with embodiments. In particular, FIG. 3A shows a side cross-sectional view of an unactivated HASEL actuator system with three pairs of opposing electrodes arranged on an inside of an external support structure, in accordance with an embodiment. FIG. 3B shows a side cross-sectional view of the HASEL actuator system of FIG. 3A, with the first and second pairs of electrodes activated, in accordance with an embodiment. FIG. 3C shows a side cross-sectional view of the HASEL actuator system of FIG. 3A, with the first and third pairs of electrodes activated, in accordance with an embodiment. FIG. 3D shows a side cross-sectional view of the HASEL actuator system of FIG. 3A, with the second and third pairs of electrodes activated, in accordance with an embodiment.

FIGS. 4A-4D show simplified schematic illustrations of a HASEL actuator system configured to provide a peristaltic wave actuation motion on the outside of a tube structure, in accordance with embodiments. In particular, FIG. 4A shows a side cross-sectional view of an unactivated HASEL actuator system with three pairs of opposing electrodes surrounding a fluid-filled pouch and arranged on an outer surface of an internal support structure, such as a tube, in accordance with an embodiment. FIG. 4B shows a side cross-sectional view of the HASEL actuator system of FIG. 4A, with the first and second pairs of electrodes activated, in accordance with an embodiment. FIG. 4C shows a side cross-sectional view of the HASEL actuator system of FIG. 4A, with the first and third pairs of electrodes activated, in accordance with an embodiment. FIG. 4D shows a side cross-sectional view of the HASEL actuator system of FIG. 4A, with the second and third pairs of electrodes activated, in accordance with an embodiment.

FIGS. 5A-5C show simplified schematic illustrations of an exemplary actuator unit, in accordance with embodiments. In particular, FIG. 5A shows a top view of a HASEL actuator unit including one pair of electrodes, in accordance with an embodiment. FIG. 5B shows a side view of the HASEL actuator unit of FIG. 5A in an unactivated state, in accordance with an embodiment. FIG. 5C shows a side view of the actuator unit of FIGS. 5A and 5B, shown here in an activated state, in accordance with an embodiment.

FIGS. 6A-6B show simplified schematic illustrations of an exemplary actuator unit within an embedding structure, in accordance with embodiments. In particular, FIG. 6A shows a side cross-sectional view of a HASEL actuator unit, incorporated within a pocket in an embedding structure, in accordance with an embodiment. FIG. 6B shows a side cross-sectional view of the HASEL actuator unit of FIG. 6B, shown with the embedding structure in a stretched state, in accordance with an embodiment.

FIGS. 7A-7C show simplified schematic illustrations of an exemplary sleeve with integrated actuators, in accordance with embodiments. In particular, FIG. 7A shows a perspective view of a sleeve with numerous actuators integrated therein, in accordance with an embodiment. FIG. 7B shows a cross-sectional view of a portion of the sleeve of FIG. 7A, shown here to illustrate one of the actuators in an unactuated state, in accordance with an embodiment. FIG. 7C shows a cross-sectional view of the actuator of FIG. 7B in an activated state, in accordance with an embodiment.

FIG. 8 shows a partial cross-sectional view of a tube with numerous actuators integrated therein, in accordance with embodiments.

FIG. 9 shows a partial cross-sectional view of a tube with an outer shell and numerous actuators separably disposed therein, in accordance with embodiments.

FIGS. 10A and 10B show simplified schematic illustrations of a portion of an actuator system, in accordance with embodiments. In particular, FIG. 10A shows a partial cross-sectional view of a portion of the actuator system including an unactuated actuator unit encapsulated within layers of material, in accordance with an embodiment. FIG. 10B shows a partial cross-sectional view of the portion of FIG. 10A with the actuator unit in an actuated state, in accordance with an embodiment.

FIG. 11 shows a cross-sectional view of an actuator unit with enhanced electrical isolation, in accordance with embodiments.

FIGS. 12A-12C show simplified schematic illustrations of a monitoring system including actuators, in accordance with embodiments. In particular, FIG. 12A shows a monitoring system with a pair of actuators in an unactivated state (i.e., “at rest”), in accordance with an embodiment. FIG. 12B shows the monitoring system of FIG. 12A with the pair of actuators in an activated state, in accordance with an embodiment. FIG. 12C shows the monitoring system of FIG. 12A with the pair of actuators in an activated so as to be able to sense the presence of an object therebetween, in accordance with an embodiment.

FIG. 13 shows a simplified schematic of an interactive actuator system, in accordance with embodiments.

FIG. 14 shows a process flow chart of an interactive actuator system, in accordance with an embodiment.

FIGS. 15A-15G show simplified schematic illustrations of an actuator system including multiple “pixels” activated with a single pouch of fluid and one electrode pair, in accordance with embodiments. In particular, FIG. 15A shows a pouch including multiple semi-circular “pixels” that are progressively activated as the electrode pair is zipped together with progressive application of voltage thereto, in accordance with an embodiment. FIG. 15B shows a front view of the actuator system of FIG. 15A in an unactivated state, in accordance with an embodiment.

FIG. 15C shows a front view of the actuator system of FIG. 15A in a further activated state, in which one row of pixels is activated, in accordance with an embodiment. FIG. 15D shows the actuator system of FIG. 15A in a still further activated state, in which two rows of pixels are activated, in accordance with an embodiment. FIG. 15E shows the actuator system of FIG. 15A in a fully activated state, with the electrode pair fully zipped and three rows of pixels activated, in accordance with an embodiment. FIG. 15F shows a partial cross-sectional side view of a variation of the actuator system of FIG. 15A in an unactivated state, in accordance with an embodiment. FIG. 15G shows a partial cross-sectional side view of the variation of the actuator system of FIG. 15A in a fully activated state, in accordance with an embodiment.

FIGS. 16A and 16B show an actuator system including a separation from the high voltage electronics from the expanding and/or contracting portion of the actuator system, in accordance with an embodiment. In particular, FIG. 16A shows a simplified schematic of an actuator system in which sensation pixels are separated from the high voltage electrode portion of the system by a prescribed distance, in accordance with an embodiment. FIG. 16B shows an exemplary embodiment of a finger pressure cuff, in which the sensation pixel (at the finger) is placed at a distance from electrode section (at the forearm), in accordance with an embodiment.

FIG. 16 shows a process flow chart of an interactive actuator system, in accordance with an embodiment.

FIGS. 17A-17B show simplified schematic illustrations of a fingered actuator system, in accordance with embodiments. In particular, FIG. 17A shows a fingered actuator system in a flattened configuration, in accordance with an embodiment. FIG. 17B shows the fingered actuator system of FIG. 17B in a ring configuration, in accordance with an embodiment.

FIG. 18 shows a simplified schematic illustration of a plurality of actuator units arranged within a spiral tube, in accordance with an embodiment.

FIG. 19 shows a simplified schematic illustration of an actuator system with a plurality of actuator units arranged in a ring configuration, in accordance with an embodiment.

### DETAILED DESCRIPTION OF THE INVENTION

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

The present disclosure describes various aspects related to the use of actuators for haptics and touchable applications, in which actuators may provide movement or sensation by contact with a person's body. A soft actuator, such as a hydraulically amplified self-healing electrostatic (HASEL) transducer, provide a better match between the properties of the transducer and user, which leads to more comfortable experience as well as more effective transmission of sensations or tactile information. The structure and operations of an actuator based on the HASEL transducer are described, for example, International Patent Application Number PCT/US18/23797, titled “Hydraulically Amplified Self-Healing Electrostatic Transducers” and filed 2018 Mar. 22, which application is incorporated herein by reference in its entirety.

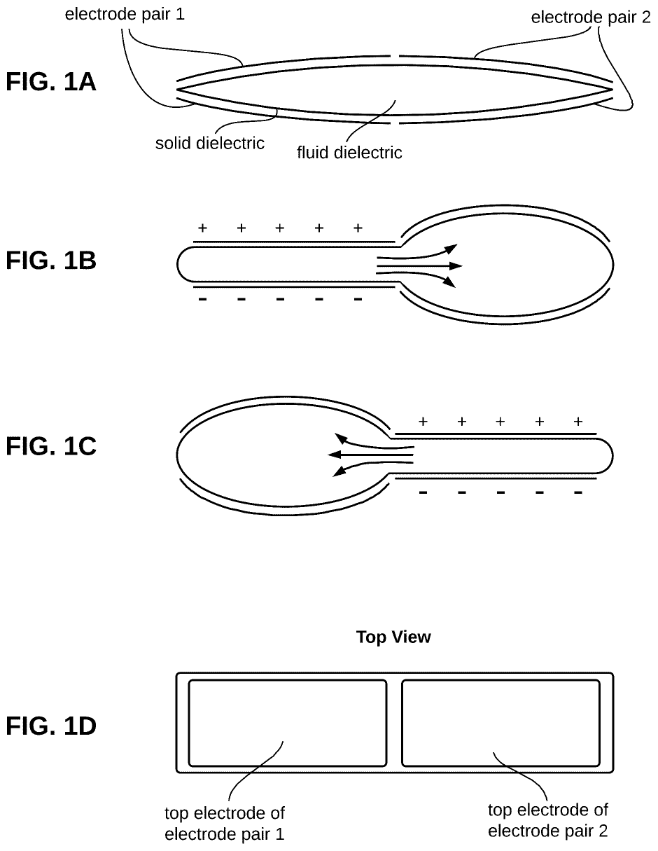

FIGS. 1A-1D show simplified schematic illustrations of a HASEL actuator, in accordance with embodiments. In particular, FIG. 1A shows a side cross-sectional view of an unactivated HASEL actuator with two pairs of opposing electrodes, in accordance with an embodiment. The HASEL actuator includes a pouch formed of a solid dielectric film and filled with a fluid dielectric. Two pairs of electrodes (electrode pair 1 and electrode pair 2) are arranged on opposing outer surfaces of the solid dielectric such that a voltage from a voltage source (now shown) may be applied across each pair of electrodes.

In embodiments, the voltage may be applied to each electrode pair independently. For example, FIG. 1B shows a side cross-sectional view of the HASEL actuator of FIG. 1A, with a first pair of electrodes activated, in accordance with an embodiment. Similarly, FIG. 1C shows a side cross-sectional view of the HASEL actuator of FIG. 1A, with a second pair of electrodes activated, in accordance with an embodiment. As shown in FIG. 1B, when electrode pair is activated by application of a voltage thereacross (as represented by the plus signs on the upper electrode of electrode pair 1 and the minus signs on the lower electrode of electrode pair 1) such that electrode pair 1 is activated, the fluid dielectric is forced toward electrode pair 2 in the directions indicated by arrows, thus causing the region between electrode pair 2 to bulge. Similarly, when electrode pair 2 is activated, the dielectric fluid is forward into the pouch volume between electrode pair 1. Such a configuration of a HASEL actuator may be operated to generate a peristaltic (e.g., “stroking”) motion.

FIG. 1D shows a top view of the HASEL actuator of FIG. 1A, in accordance with an embodiment. In the embodiment illustrated in FIG. 1D, the HASEL actuator is shown with a pouch having a rectangular overall shape, with each electrode pair being shaped rectangularly. It is noted that other pouch and electrode shapes are contemplated and are considered to be a part of the present disclosure.

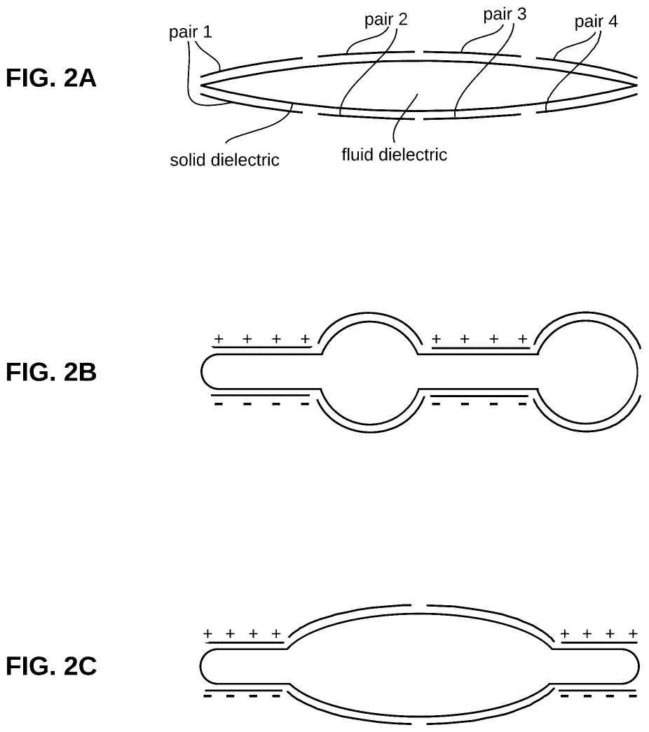

FIGS. 2A-2C show simplified schematic illustrations of an alternative HASEL actuator with multiple pairs of opposing electrodes, in accordance with embodiments. In particular, FIG. 2A shows a side cross-sectional view of an unactivated HASEL actuator with four pairs of opposing electrodes, in accordance with an embodiment. Again, in embodiments, each pair of electrodes may be individually addressable such that each electrode pair may be activated independently.

FIG. 2B shows a side cross-sectional view of the HASEL actuator of FIG. 2A, with first and third pairs of electrodes activated, in accordance with an embodiment. FIG. 2C shows a side cross-sectional view of the HASEL actuator of FIG. 2A, with first and fourth pairs of electrodes activated, in accordance with an embodiment. In certain embodiments, cross activation of electrode pairs (e.g., the top electrode of pair 2 and the bottom electrode of pair 3) may induce a rippling or twisting motion of the alternative HASEL actuator. By activating the electrode pairs sequentially in a preset order (e.g., electrode pairs 1, 2, 3, and 4 activated in order or in combinations thereof), the HASEL actuator illustrated in FIGS. 2A-2C may be used to peristaltic motion that may be varied in direction (e.g., left to right in the illustrated example) and intensity (e.g., smaller pulsations as shown in FIG. 2B or larger bulging as shown in FIG. 2C). It is noted that the size of the pouch, the amount of fluid dielectric contained in the pouch, and the number of electrode pairs may be varied according to the amount of fluid displacement, sensation, and performance desired.

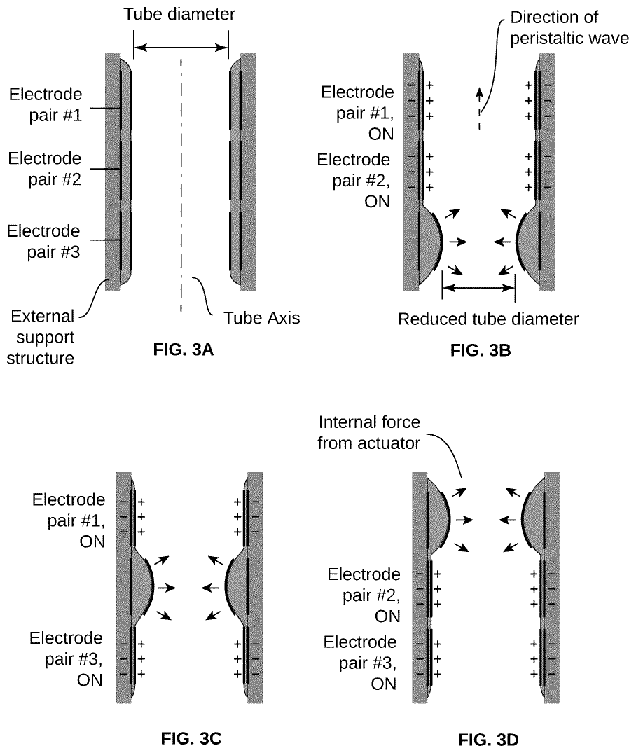

FIGS. 3A-3D show simplified schematic illustrations of a HASEL actuator system configured to provide a peristaltic wave actuation motion, in accordance with embodiments. In particular, FIG. 3A shows a side cross-sectional view of an unactivated HASEL actuator system with three pairs of opposing electrodes surrounding a pouch filled with a dielectric fluid and arranged on an inside of an external support structure, in accordance with an embodiment. For example, the electrode pairs may be arranged as rings within an external support structure formed as a tube with a tube axis and tube diameter as shown. The tube may be formed of a stiff material (e.g., plastic or metal), a flexible material (e.g., elastic tubing or foam), or a combination thereof. In embodiments, the portion of the pouch proximate to the tube may be formed of a stiffer material than the portion of the pouch facing the tube axis to encourage the deformation of the pouch inward toward the tube axis, when the electrode pairs of the HASEL actuator system is activated.

FIG. 3B shows a side cross-sectional view of the HASEL actuator system of FIG. 3A, with electrode pairs #1 and #2 activated, in accordance with an embodiment. With electrode pairs #1 and #2 activated, the fluid dielectric is displaced into the region under electrode pair #3, thus reducing the tube diameter in the inner tube volume adjacent to electrode pair #3, as shown in FIG. 3B.

In this way, the fluid dielectric may be moved along the length of the tube by activating the electrode pairs sequentially, thus causing a peristaltic, pumping motion. For instance, FIG. 3C shows a side cross-sectional view of the HASEL actuator of FIG. 3A, with the electrode pairs #1 and #3 activated, in accordance with an embodiment. FIG. 3D shows a side cross-sectional view of the HASEL actuator of FIG. 3A, with the electrode pairs #2 and #3 activated, in accordance with an embodiment. In this way, the volume of fluid dielectric is moved from under electrode pair #3 (as shown in FIG. 3B) to under electrode pair #2 (as shown in FIG. 3C) to under electrode pair #1 (as shown in FIG. 3D). This peristatic motion may be applied to an object or appendage placed within the tube to provide a variety of sensations and/or haptic feedback.

In the exemplary embodiment shown in FIGS. 3A-3D, the HASEL actuator system includes three pairs of electrodes disposed on opposing sides of a pouch formed of a solid dielectric and containing a fluid dielectric. In embodiments, the pouch may extend along the length of the tube as an inner liner. Further, the electrode pairs shown on either side of the tube diameter may be electrically connected together such that each electrode pair is formed from a pair of electrode rings disposed on opposing surfaces of the pouch. In other embodiments, the electrode pairs and/or pouches on either side of the tube diameter may be mechanically and electrically separated to enable further variations in the peristaltic motion provided by the illustrated HASEL actuator system.

The rate, duration, and intensity of the electrode activation (thus peristaltic motion transferred to the object disposed within the tube) may be varied by an actuator control unit (not shown). For instance, the actuator control unit may regulate the activation of the different electrode pairs to ensure no more than two (or any other predetermined number when fewer or additional electrode pairs are provided within the system) of the electrode pairs are simultaneously activated in order to avoid excessive force on the pouch, thus preventing potential bursting of the pouch. Furthermore, additional layers may be placed over the inner surface of the tube to provide electrical insulation, isolation from abrasion, gripping features (e.g., striations or bumps), or other mechanical inputs.

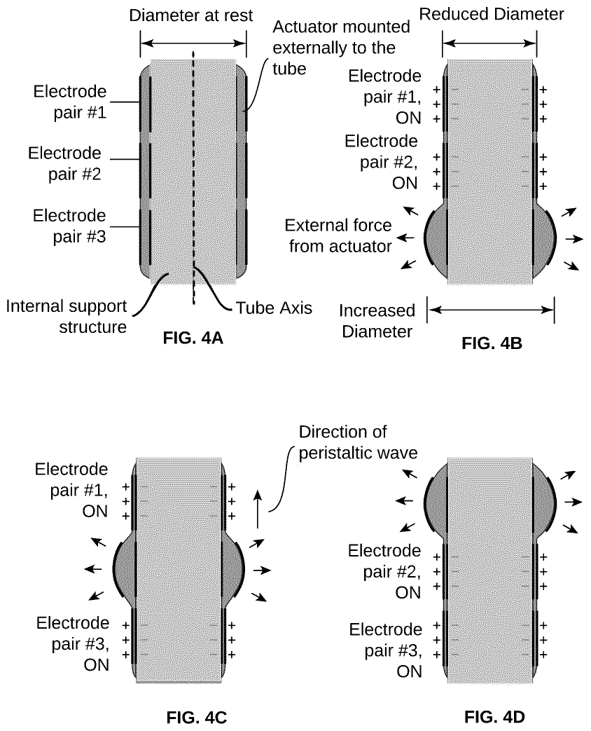

FIGS. 4A-4D show simplified schematic illustrations of a HASEL actuator system configured to provide a peristaltic wave actuation motion on the outside of a tube structure, in accordance with embodiments. In particular, FIG. 4A shows a side cross-sectional view of an unactivated HASEL actuator system with three pairs of opposing electrodes surrounding a fluid-filled pouch and arranged on an outer surface of a support structure, such as a tube, in accordance with an embodiment.

The support structure may be formed of a stiff material, such as a plastic or metal, or a more pliable material, such as an extruded foam or a casing containing a spring or beads, as long as the outer surface of the support structure provides sufficient mechanical resistance such that, when actuated, the In an embodiment, the HASEL actuator system may be formed as a single pouch surrounding an outer portion of a tubular support structure, with multiple electrode pairs disposed on inner and outer portions of the pouch. In embodiments, the portion of the pouch proximate to the tube may be formed of a stiffer material than the outward-facing portion of the pouch so as to encourage the deformation of the pouch outward from the support structure, when the electrode pairs of the HASEL actuator system is activated. For instance, if the support structure is formed of a pliable material, the pouch portion proximate to the tube may be formed of a material that is sufficiently stiff to promote an outward deformation of the pouch when the electrode pairs are activated, while also being sufficiently pliable to bend with the support structure as needed.

As shown in FIG. 4A, the electrode pairs may be provided as continuous ring-like bands surrounding the support structure, or as discrete, discontinuous patches around the support structure. While three electrode pairs are shown in FIG. 4A, fewer or additional electrode pairs may be provided, according to the desired actuation effect. When all electrode pairs are unactivated, the outer diameter of the HASEL actuator system is uniform and flat.

FIG. 4B shows a side cross-sectional view of the HASEL actuator system of FIG. 4A, with the electrode pairs #1 and #2 activated, in accordance with an embodiment. Due to the presence of the support structure, the circumference of the HASEL actuator system is reduced at the location of electrode pairs #1 and #2, as the dielectric fluid at the location of electrode pairs #1 and #2 are displaced toward the location of electrode pair #3. Consequently, the circumference of the HASEL actuator system is increased at the location of electrode pair #3. In this way, the diameter of the overall system is increased and an external, outward force is also created at the location of electrode pair #3.

FIG. 4C shows a side cross-sectional view of the HASEL actuator system of FIG. 4A, with electrode pairs #1 and #3 activated, in accordance with an embodiment. In this situation, the dielectric fluid within the pouch is displaced to the location of electrode pair #2, thus causing the circumference of the HASEL actuator system to increase at the location of electrode pair #2, while the circumference is reduced at electrode pairs #1 and #3 as these electrode pairs zip together.

Similarly, FIG. 4D shows a side cross-sectional view of the HASEL actuator system of FIG. 4A, with electrode pairs #2 and #3 activated such that the dielectric fluid gathers at the location of electrode pair #1. In this way, the pocket of dielectric fluid may be caused to move along the length of the support structure, causing a peristaltic pumping motion along the outer surface of the tubular support structure. This external, outward force may be applied to an object or appendage to provide a variety of sensations and/or haptic feedback. Again, the rate, duration, and intensity of the electrode activation may be varied by an actuator control unit (not shown), including safety measures such as ensuring one or more of the electrode pairs remains unactivated at any given time. As an example, a power source and/or actuator control unit may be located within the tubular support structure. Furthermore, additional layers may be placed outside the HASEL actuator system provide electrical insulation, isolation from abrasion, gripping features (e.g., striations or bumps), other mechanical inputs, or for sanitation.

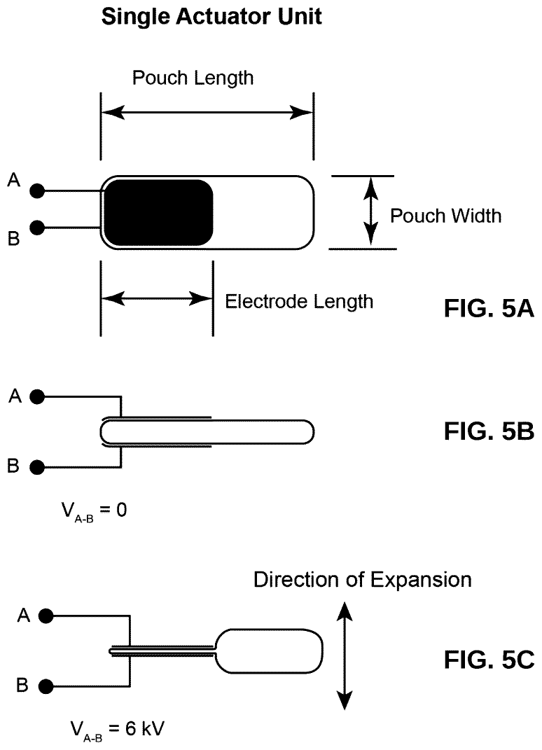

FIGS. 5A-5C show simplified schematic illustrations of an exemplary actuator unit, in accordance with embodiments. In particular, FIG. 5A shows a top view of a HASEL actuator unit including one pair of electrodes, in accordance with an embodiment. In the illustrated example, the actuator unit includes a pouch, filled with a dielectric fluid and having a generally rectangular shape with a pouch length and a pouch width. A pair of electrodes, each electrode being connected with an input A or an input B, is disposed on opposing surfaces of the pouch. As shown, each electrode has a width slightly smaller than the pouch width and an electrode length that is approximately half of the pouch length.

FIG. 5B shows a side view of the HASEL actuator unit of FIG. 5A in an unactivated state, in accordance with an embodiment. As shown in FIG. 5B, when no voltage is applied across the electrode pair (i.e., VA-B=OV), the pouch exhibits a substantially uniform thickness across the pouch length.

FIG. 5C shows a side view of the actuator unit of FIGS. 5A and 5B, shown here in an activated state, in accordance with an embodiment. When a voltage (e.g., VA-B=6 kV in the illustrated example), is applied across the electrode pair, the electrodes zip together to force the dielectric fluid to be displaced to the region of the pouch not covered by electrodes. This fluid displacement causes the pouch to expand in the thickness direction, as indicated by a double-headed arrow showing the direction of expansion in FIG. 5C, while slightly reducing the overall pouch length.

The actuator unit illustrated in FIGS. 5A-5C is a representative example of actuators that may be integrated into the various embodiments illustrated herein to provide sensations and haptic information, for example. Other geometries and designs for the actuator unit may be contemplated, including the use of a variety of geometries within a single integrated system, and are considered a part of the present disclosure. For instance, variables such as pouch length, pouch width, electrode size, and ratio of the electrode surface area to the overall pouch surface area may be modified to obtain desired actuator system performance. Further, multiple electrode pairs may be disposed on a single pouch (e.g., as shown in FIGS. 1A-4D), or multiple actuator units may be arranged as a stack, a chain, or an array, with appropriate electrical isolation and safety measures taken to ensure the user of the actuator system is protected from the voltage applied to the actuator units.

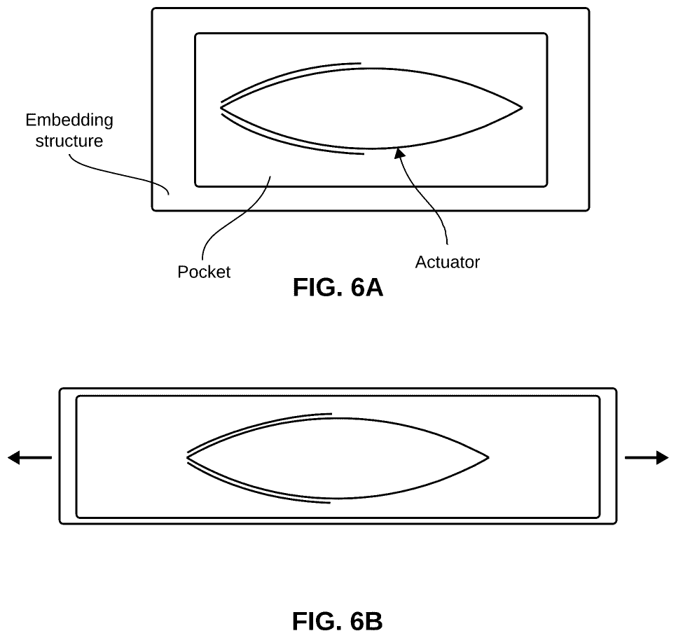

FIGS. 6A-6B show simplified schematic illustrations of an exemplary actuator unit within an embedding structure, in accordance with embodiments. In particular, FIG. 6A shows a side cross-sectional view of a HASEL actuator unit, incorporated within a pocket in an embedding structure, in accordance with an embodiment. The actuator unit may be, for example, an actuator unit as illustrated in FIGS. 5A-5C. As shown in FIG. 6A, a single actuator unit is surrounded by a pocket or a void within the embedding structure, such as a stretchable fabric.

FIG. 6B shows a side cross-sectional view of the HASEL actuator unit of FIG. 6B, shown with the embedding structure in a stretched state, in accordance with an embodiment. The embedding structure may be formed, for example, of a low-friction material such as nylon or elastane to enable the embedding structure to stretch or otherwise deform without affecting the shape of the actuator. This arrangement enables the decoupling of the mechanics of the embedding structure from the operation of the actuator embedded therein. For instance, the embedding structure may be formed of an elastic material to enable an adjustable fit of a HASEL actuator system on appendages of a variety of sizes. A variety of elastic materials may be contemplated and are considered a part of the present disclosure. Further, in embodiments, the actuator units may be configured to be removable from the embedding structure such that the embedding structure may be separately washable without potential damage to the electronic components of the actuator units.

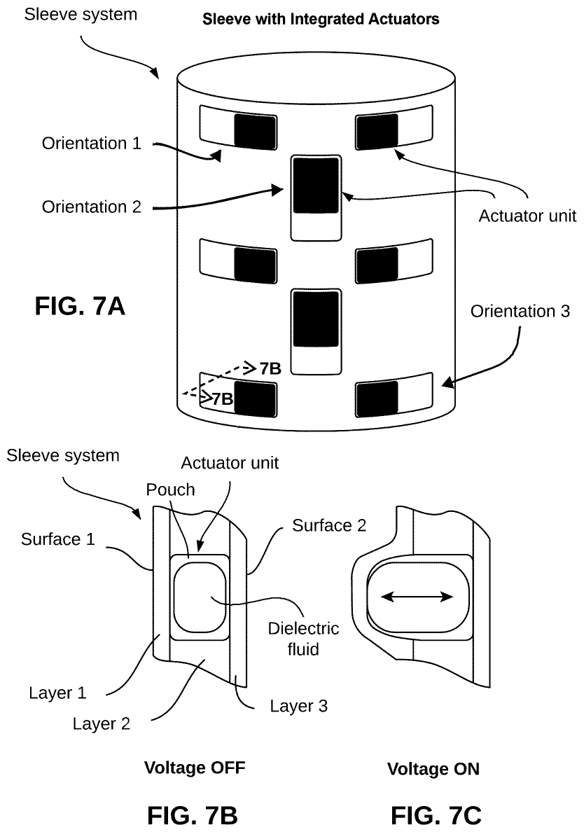

FIGS. 7A-7C show simplified schematic illustrations of an exemplary sleeve with integrated actuators, in accordance with embodiments. In particular, FIG. 7A shows a perspective view of a sleeve with numerous actuators integrated therein, in accordance with an embodiment. The sleeve may be configured with the appropriate dimensions to be wearable, for example, on an appendage such as a finger or an arm, or mounted onto another object, such as a tubular support structure as shown in FIGS. 4A-4D, for interaction with a user.

In embodiments, the actuator units integrated into the sleeve of FIG. 7A may be configured in a manner as illustrated in FIGS. 6A-6B, with the actuator units being accommodated within pockets provided within the sleeve. As shown in FIG. 7A, a plurality of actuator units may be integrated into the sleeve, and the orientation of the actuator units need not be uniform. For example, actuator units may be disposed in an Orientation 1 (i.e., horizontally aligned with the circumference of the sleeve, with the electrode pair located toward the right-hand side of the drawing), an Orientation 2 (i.e., vertically aligned with the length of the sleeve), an Orientation 3 (i.e., horizontally aligned with the circumference of the sleeve, with the electrode pair located toward the left-hand side of the drawing), or in other orientations (e.g., diagonally, grouped according to orientation in specific areas on the sleeve).

FIG. 7B shows a cross-sectional view of a portion of the sleeve of FIG. 7A, shown here to illustrate one of the actuator units in an unactuated state, in accordance with an embodiment. In the illustrated embodiment, an actuator unit, including a pouch with a dielectric fluid contained therein, is embedded within the sleeve system. For instance, the actuator unit may be encapsulated between layers 1, 2, and 3. Layers 1, 2, and/or 3 may further serve as an insulator between the actuator unit and the user, who comes into contact with surface 1 and/or 2. FIG. 7C shows a cross-sectional view of the actuator unit of FIG. 7B in an activated state, in accordance with an embodiment.

In an embodiment, at least layer 1 is formed of an elastic or a soft or very stretchable material that deforms easily when the actuator unit is activated. Possible materials for layer 1 include many types of soft and stretchable elastomers such as silicone, natural rubber, nitrile, neoprene, and a thermoplastic vulcanizate such as SANTOPRENE® TPV.

In certain embodiments, layer 3 may be formed of a stiffer or non-stretchable material compared with layer 1 such that, when the actuator unit is activated, the pouch of the actuator unit preferentially expands toward surface 1 of layer 1, while surface 2 of layer 3 remains unaltered. Suitable materials for layer 3 include, for example, a natural or synthetic fabric such as nylon, polyester, silk, cotton, aramid, elastane, polyethylene, and acrylic. Layer 3 may also be made from the same material as layer 1 or a similar elastomer that is stiffer due to higher modulus of elasticity or thickness.

Layer 2 separates layers 1 and 3 and may be designed to match the resting thickness of the actuator units. In embodiments, Layer 2 may include pockets for accommodating actuator units therein as well as provisions for routing actuator electrical connections therethrough. For example, electrical filaments may be integrated into layer 2. A user of the sleeve may be in contact with surface 1 and/or 2. In embodiments, layers 1, 2, and/or 3 may be integrally formed as a monolithic structure molded in one or two parts.

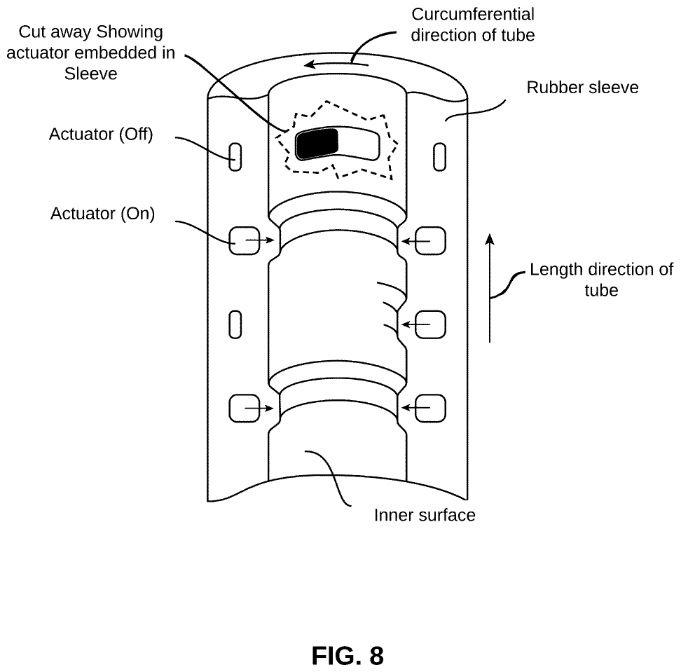

FIG. 8 shows a partial cross-sectional view of a tube with numerous actuators integrated therein, in accordance with embodiments. In an example, the tube may be a rubber sleeve with a number of actuator units integrated therein. The actuator units may be provided as rings embedded within the rubber sleeve, as individual units (e.g., as shown in FIGS. 5A-5C), or a combination thereof. A network of electrical connections may be integrated into the rubber sleeve such that each one of the actuator units may be independently activated while enabling electrical isolation of each actuator unit from each other as well as from the user. In certain embodiments, the actuator units and electrical connections may be completely embedded within the rubber sleeve such that the rubber sleeve may be immersed in a liquid for cleaning as necessary. The rubber sleeve may be reusable or disposable.

In embodiments, the actuators may be activated in a sequence along a length direction of the tube (as indicated by an arrow) to produce a peristaltic motion. Alternatively or simultaneously, an actuator unit may be activated along a circumferential direction of the tube by a zipping motion of a ring-shaped actuator unit.

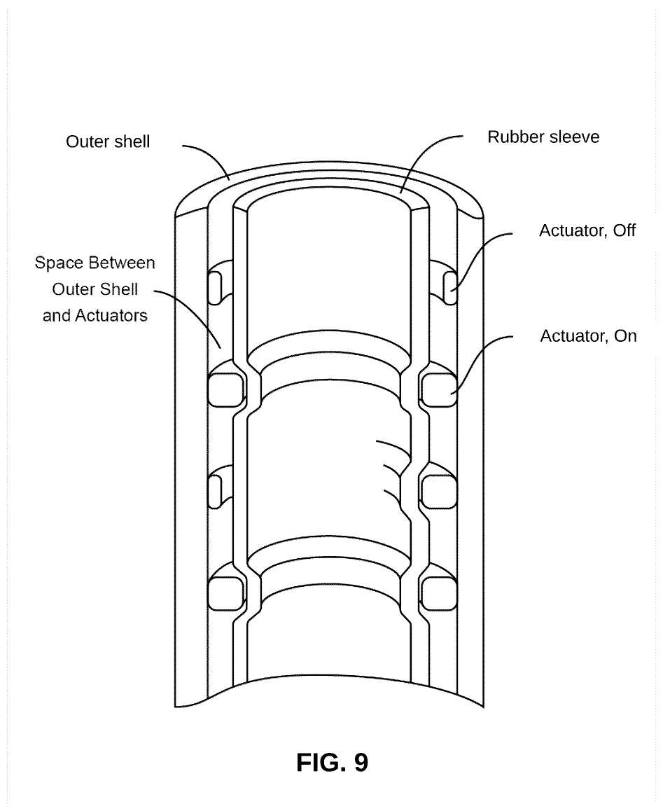

FIG. 9 shows a partial cross-sectional view of an actuator system including a tube with an outer shell and numerous actuators separably disposed therein, in accordance with embodiments. As shown in FIG. 9, ring-like actuator units are disposed between an outer shell and an inner rubber sleeve, which comes into contact with an appendage of a user. For example, the actuator units may be affixed to the outer shell then, for each use of the actuator system, the inner rubber sleeve is replaced for sanitation. The outer shell may include grooves for accommodating the actuator units therein. Actuator units may be provided in ring format or in other formats, according to the desired motion to be effected by the actuator system.

The inner rubber sleeve may be formed of an elastic material other than rubber, and maybe disposable, sanitizable, and/or replaceable. The outer shell may be formed as a single part or assembled from multiple components made from a stiff material such as acrylonitrile butadiene styrene, polypropylene, polyethylene terephthalate, or another plastic that may be injection or extrusion molded.

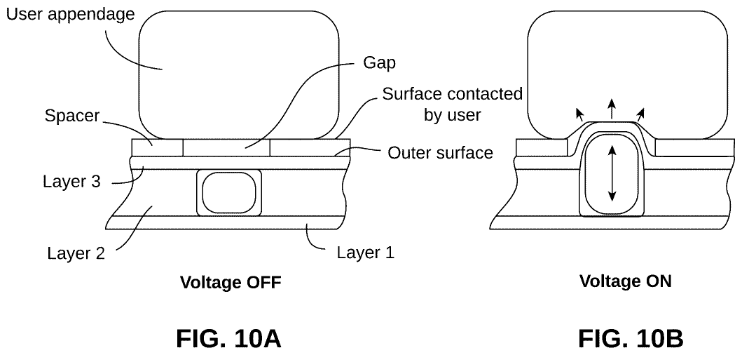

FIGS. 10A and 10B show simplified schematic illustrations of a portion of an actuator system, in accordance with embodiments. In particular, FIG. 10A shows a partial cross-sectional view of a portion of the actuator system including an unactuated actuator unit encapsulated within layers of material, in accordance with an embodiment. As an example, the unactuated actuator unit may be embedded within layers 1, 2, and 3, similarly to the embodiment illustrated in FIG. 7B. FIG. 10A further shows a spacer layer including a gap (i.e., opening) disposed between a user appendage and the encapsulated actuator.

FIG. 10B shows a partial cross-sectional view of the portion of FIG. 10A with the actuator unit in an actuated state, in accordance with an embodiment. The expansion range of the actuator unit is configured such that, once the electrode pair of the actuator unit is activated by turning on the voltage thereto, the actuator unit expands through the gap and contacts the user appendage. The initial gap present between the actuator unit and the user appendage allows the initial contact of the actuator unit with the user appendage to be more noticeable for the user, compared to if the user were in constant contact with the outer surface of the actuator system. Such enhancement of tactile stimulation may be particularly desirable, for example, for providing haptic feedback.

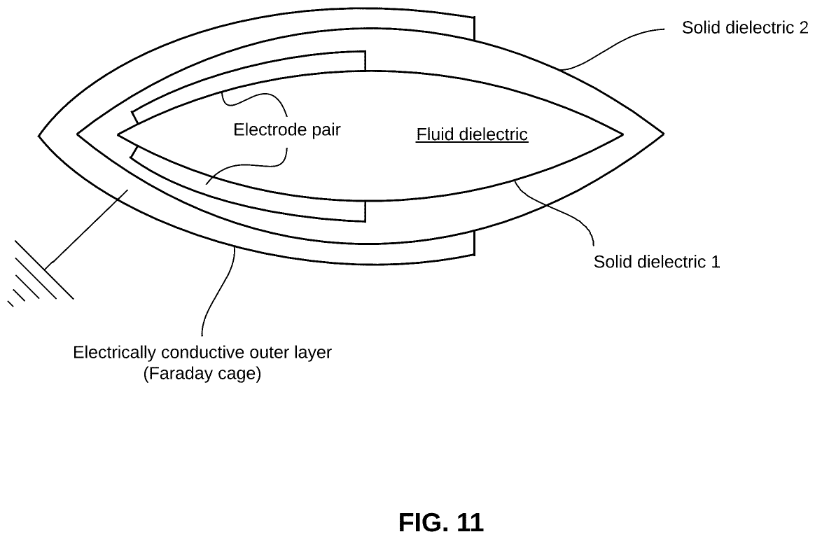

FIG. 11 shows a cross-sectional view of an actuator unit with enhanced electrical isolation, in accordance with embodiments. As shown in FIG. 11, a HASEL actuator unit (e.g., similar to those illustrated in FIGS. 1A-2C and 5A-5C) includes a pouch formed of a solid dielectric 1 with a fluid dielectric contained therein and a pair of electrodes provided on opposing surfaces of the pouch. A second dielectric material (shown as solid dielectric 2) is provided to surround the HASEL actuator unit for additional isolation of the HASEL actuator unit from external electrical connectivity.

Additionally, an electrically conductive outer layer is provided over at least a portion of the outside surface of the second dielectric material. This electrically conductive outer layer may then be connected to a low potential (i.e., ground) so as to essentially function as a Faraday cage, thereby effectively isolating the user from the voltage used to activate the HASEL actuator unit. Such electrical isolation may further enhance the safety aspects of using the various embodiments described above to prevent unwanted shock being experienced by the user.

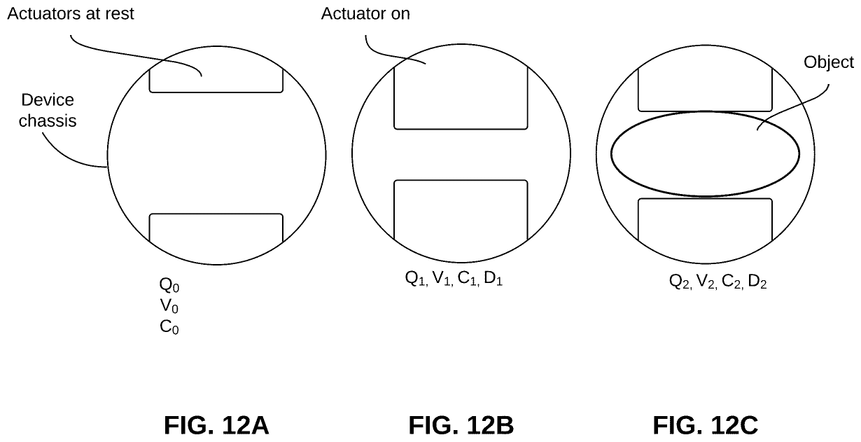

FIGS. 12A-12C show simplified schematic illustrations of a monitoring system including actuators with self-sensing capabilities, in accordance with embodiments. By taking advantage of the sensing and feedback capabilities of the HASEL actuators, the above described embodiments of actuator systems may be further enhanced with the ability to infer user information, in addition to providing haptic sensations.

In particular, FIG. 12A shows a monitoring system with a pair of actuators in an unactivated state (i.e., “at rest”), in accordance with an embodiment. As shown in FIG. 12A, the initial charge (Q₀), initial voltage (V₀), and initial capacitance (C₀) as measured at the actuators are noted as having baseline values. The pair of actuators may be supported, for example, within a device chassis (as shown) or in a support structure (e.g., as shown in FIG. 3A-3C, 8, or 9).

FIG. 12B shows the monitoring system of FIG. 12A with the pair of actuators in an activated state without any object placed therebetween, in accordance with an embodiment. With the activated actuators as shown in FIG. 12B, the activated charge (Q₁), activated voltage (V₁), activated capacitance (C₁), and activated displacement (D₁) at the actuator units may be assessed. In the situation shown in FIG. 12B, Q₁>Q₀, V₁>V₀, and C₁>C₀.

FIG. 12C shows the monitoring system of FIG. 12A with the pair of actuators in an activated with an object placed therebetween, in accordance with an embodiment. The actuators in FIG. 12C may then be assessed for values of the modified charge (Q₂), modified voltage (V₂), modified capacitance (C₂), and modified displacement (D₂). In the presence of the object, the modified values (from FIG. 12C) and the activated values (from FIG. 12B) should be related such that Q₂=Q₁, C₂<C₁, V₂>V₁, and D₂<D₁. In particular, the displacement relationship (i.e., D₁>D₂) indicates that the presence of an object located between the actuator units is preventing the actuator units from achieving the full displacement distance D₁ achievable if there were no object.

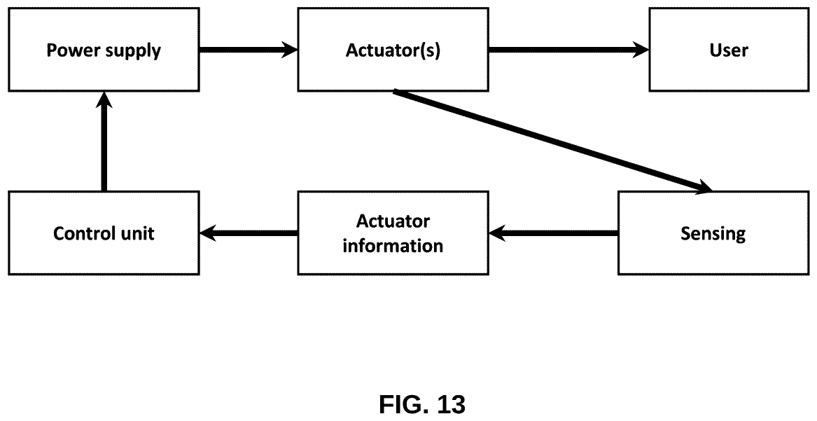

FIG. 13 shows a simplified schematic of an interactive actuator system, in accordance with embodiments. As shown in FIG. 13, an interactive actuator system may include a power supply providing power to one or more actuators, wherein the output from the power supply is controlled by a control unit. The actuators in turn provide tactile sensations to a user. Simultaneously, actuator information (e.g., displacement, force, conductivity, resistance, capacitance, charge) may be sensed and sent to a control unit. In embodiments, the actuator information may be collected by the actuators themselves (e.g., as shown in FIGS. 12A-12C) or by one or more separate sensors provided at the actuator units within the interactive actuator system. Based on the actuator information received at the control unit, the control unit adjusts the input to the power supply so as to adjust the output from the power supply. For instance, the actuator information may be used to assess actuator operations as well as to ensure device safety for the user such as by recognizing short circuits, faulty connections, electrical arcs, or other hazardous conditions that may be inferred from the actuator information so collected.

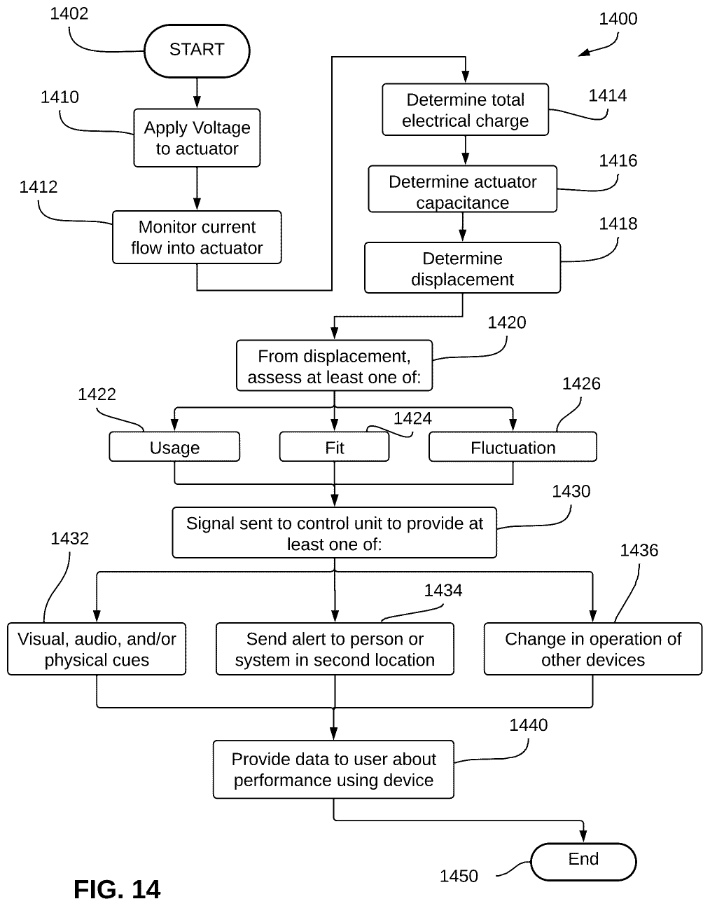

FIG. 14 shows a process flow chart of an interactive actuator system, in accordance with an embodiment. In particular, the self-sensing capabilities of the HASEL actuators enable heretofore unavailable features such as automatic adjustment of the fit of a wearable device, activation of the wearable device to provide feedback to a user, implementation of additional features, among others.

A process 1400 illustrated in FIG. 14 begins with a start step 1402 and proceeds to a step 1410 to apply voltage to one or more actuators. The process proceeds to steps to obtain various actuator information, such as a step 1412 to monitor the current flow into the actuator, a step 1414 to determine the total electrical charge at the actuator, a step 1416 to determine actuator capacitance, and a step 1418 to determine actuator displacement. From the actuator displacement (and optionally incorporating other actuator information), a step 1420 performs an assessment of at least one of usage 1422 (i.e., whether or not the actuator system is in use at a given time), fit 1424 (i.e., how well the actuator system fits the user in order to efficiently transmit sensations and/or haptic feedback to the user), and/or fluctuation 1426 (i.e., if there is significant and/or unexpected changes in the measured values of actuator information). As a result of assessments 1422, 1424, and 1426, process 1400 proceeds to a step 1430 to send a signal to the control unit to provide at least one of visual/audio/physical cues 1432 to the user, provide an alert to a person or system in a second location 1434, and/or change the operation of other device (e.g., speed or intensity of operation of peripheral devices associated with the actuator system). Process 1400 then proceeds to a step 1440 to provide data to the user related to the assessed performance regarding device performance, such as using a user interface screen, visual/audible/haptic feedback, or other manner. The process terminates in an end step 1450.

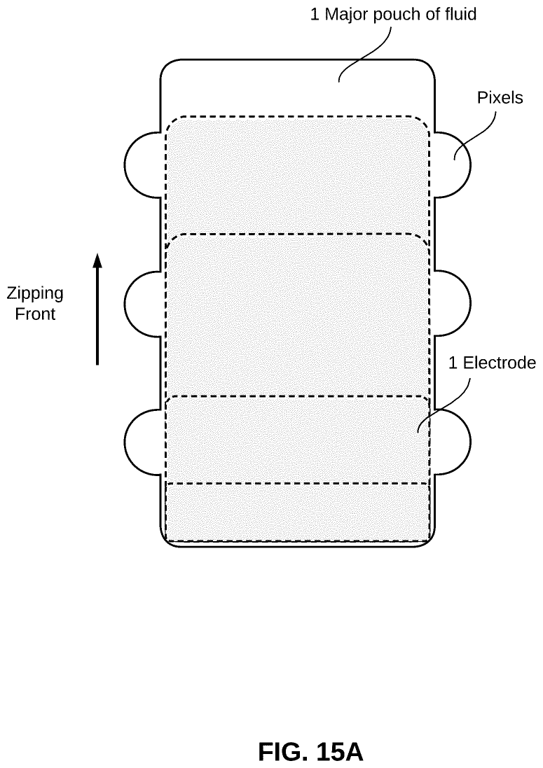

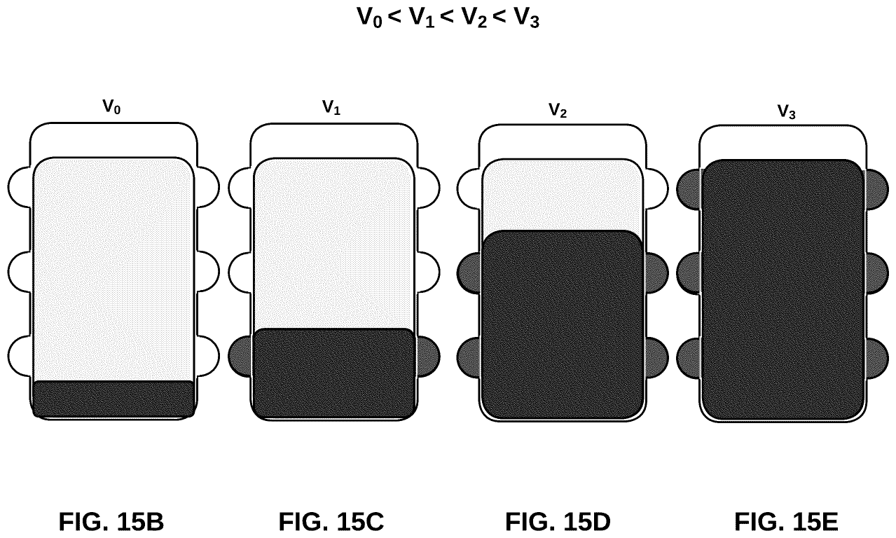

FIGS. 15A-15G show simplified schematic illustrations of an actuator system including multiple “pixels” activated with a single pouch of fluid and one electrode pair provided on opposing sides of the pouch, in accordance with embodiments. In particular, FIG. 15A shows a pouch including multiple semi-circular “pixels” that are progressively activated as the electrode pair is zipped together with progressive application of voltage thereto, in accordance with an embodiment.

As increasing voltage is applied across the electrodes, the zipping action of the electrode pair moves a zipping front of the electrodes (i.e., the edge of the line along which the electrodes have fully zipped together) such that progressively increased numbers of “pixels” (shown as semi-circular regions protruding from the pouch, as shown in FIGS. 15A-15E) are filled with fluid and allowed to expand (i.e., “activated”).

FIG. 15B shows a front view of the actuator system of FIG. 15A in an unactivated state with an initial voltage V₀ applied across the electrode pair, in accordance with an embodiment. FIG. 15C shows a front view of the actuator system of FIG. 15A in a further activated state with a voltage V₁ applied thereto such that one row of pixels is activated, in accordance with an embodiment. FIG. 15D shows the actuator system of FIG. 15A in a still further activated state with a voltage V₂ applied thereto such that two rows of pixels are activated, in accordance with an embodiment. FIG. 15E shows the actuator system of FIG. 15A in a fully activated state, with a voltage V₃ applied across the electrodes such that the electrode pair is fully zipped and three rows of pixels activated, in accordance with an embodiment. In the illustrated embodiment, the applied voltage values are related such that V₀<V₁<V₂<V₃.

It is noted that the actuator system operation scheme illustrated in FIGS. 15A-15E may be expanded to any number of pixels. As the activated pixels themselves do not have voltage applied thereacross, the activated pixels are safe to touch. While the pixels are shown as having semi-circular shape in the figures, other shapes may be contemplated and are considered a part of the present disclosure. Further, multiple stacks or serial arrangements of the actuator system of FIGS. 15A-15E may be contemplated in order to achieve different sensations and haptic feedback effects.

FIG. 15F shows a partial cross-sectional side view of a variation of the actuator system of FIG. 15A in an unactivated state, in accordance with an embodiment. As shown in the exemplary embodiment illustrated in FIG. 15F, rather than having semi-circular (other) pixel features pre-formed into the pouch, one of the electrodes in the electrode pair may be provided with one or more gaps. Then, as shown in FIG. 15G, when a voltage is applied across the electrode pair and the electrodes are zipped together, the dielectric fluid contained within the pouch forces the pouch to protrude through the gaps in the electrode to function as the activated pixels. Such a configuration may be advantageous for simplifying the fabrication of the pouch as shown in FIGS. 15A-15E.

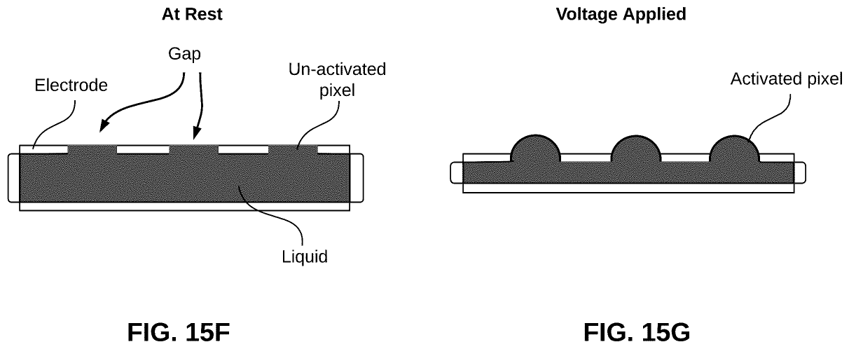

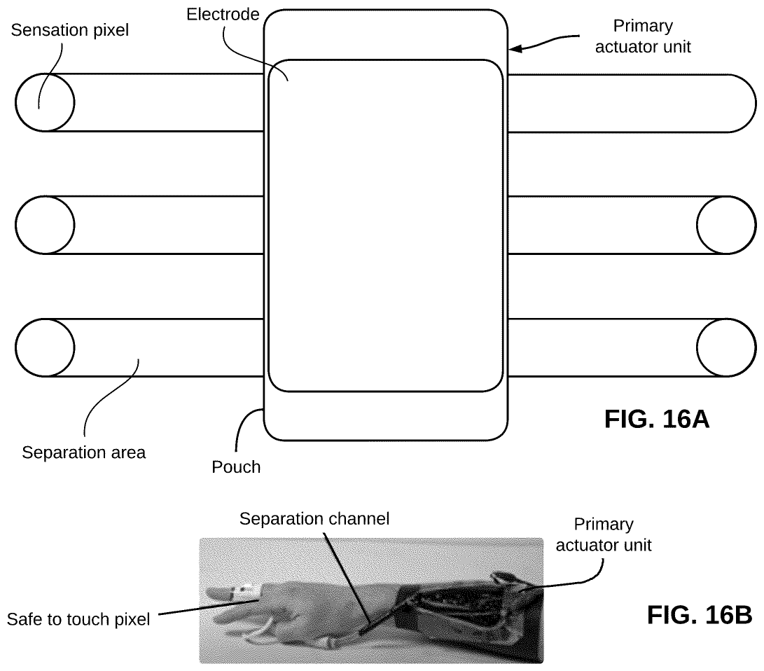

FIGS. 16A and 16B show an actuator system including a separation from the high voltage electronics from the expanding and/or contracting portion of the actuator system, in accordance with an embodiment. In particular, FIG. 16A shows a simplified schematic of an actuator system in which sensation pixels are separated from the high voltage electrode portion of the system (i.e., primary actuator unit) by a prescribed distance, in accordance with an embodiment. As shown in FIG. 16A, one or more sensation pixels may be attached to a primary actuator unit, which is separated from the sensation pixels by a separation area, represented by tubes in FIG. 16A. In this way, the sensation pixels are located away from the electrical components (e.g., electrode pair), thus enhancing user safety.

FIG. 16B shows an exemplary embodiment of a finger pressure cuff, in which the sensation pixel (at the finger) is placed at a distance from electrode section (at the forearm), in accordance with an embodiment. As shown in FIG. 16B, the electrode section mounted at the forearm acts as the primary actuator unit, including a dielectric fluid reservoir, connected with a pressurized cuff near the fingertip. For instance, the sensation pixel at the fingertip may be connected by fluid tubing to the primary actuator unit, which activates the sensation pixel by activation of one or more HASEL actuator units to selectively pump fluid toward the sensation pixel.

Rather than mounting a high voltage electronics system at the location of the sensation pixel, the sensation or haptics feedback is transferred to a remote location from the primary actuation system. While the primary actuation system is shown as being mounted on a forearm in FIG. 16B, the primary actuation system may be located as a separate unit that is not worn by the user, as an alternative.

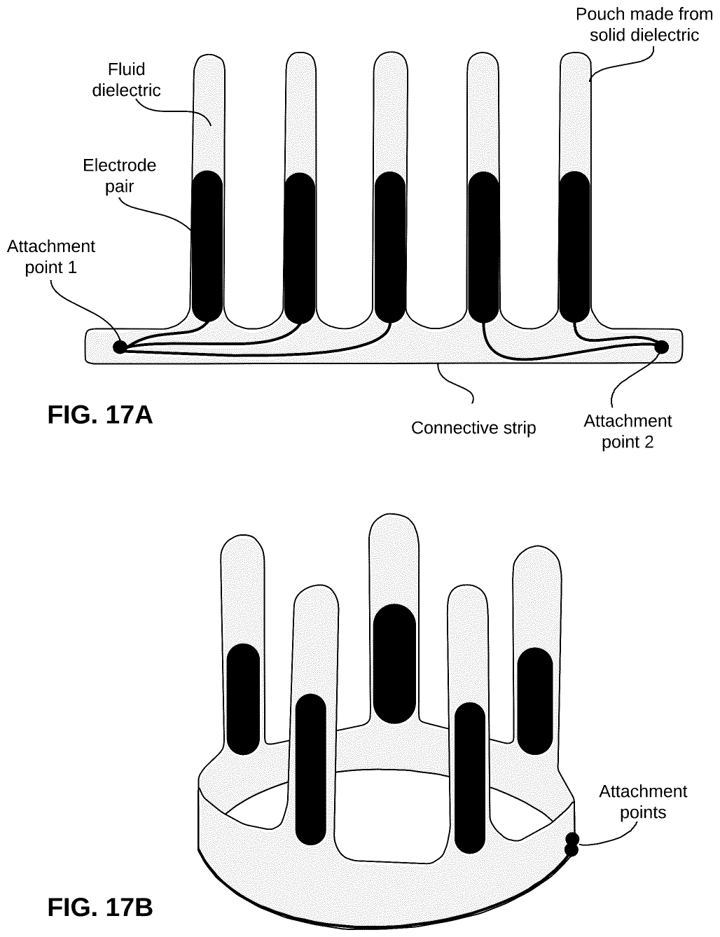

FIGS. 17A-17B show simplified schematic illustrations of a fingered actuator system, in accordance with embodiments. In particular, FIG. 17A shows a fingered actuator system in a flattened configuration, in accordance with an embodiment. For example, the fingered actuator system of FIG. 17A may be constructed as a flat sheet with multiple fingers and electrical connections integrated into a connective strip. It may be noted that, while only the electrical connection from the front electrode of each electrode pair is shown in FIG. 17A, a separate electrical connection from the back electrode (not visible in FIG. 17A) of each electrode pair would be necessitated to enable application of a voltage across the electrode pair of each finger, in accordance with the teachings above with respect to the operations of a HASEL actuator. Each one of the fingers may be controlled independently or simultaneously.

In embodiments, the connective strip may include attachment points for providing electrical connections. For instance, FIG. 17B shows the fingered actuator system of FIG. 17A in a ring configuration, in accordance with an embodiment. As shown, the attachment points on either end of the connective strip may be used to hold the fingered actuators in a cylindrical configuration while providing a location for electrical connection. For example, this cylindrical structure may then be embedded in an elastomer matrix or another support structure (not shown). It is noted that the electrical connections integrated into the connective strip are not shown in FIG. 17B for illustrative clarity. In embodiments, when activated, this cylindrical configuration provides a stroking and/or squeezing motion to an appendage placed within the cylinder.

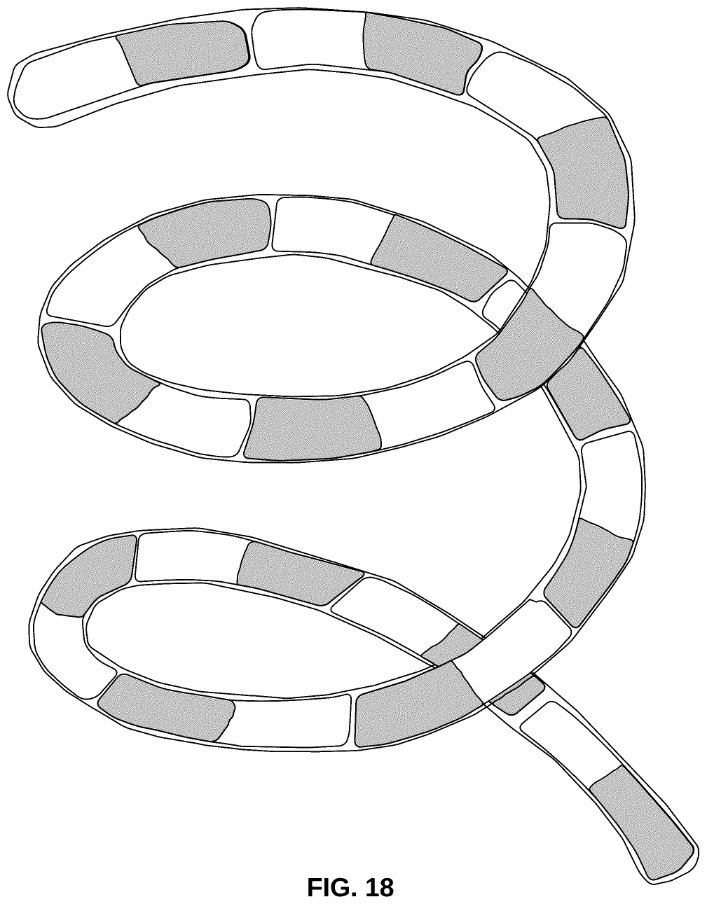

FIG. 18 shows a simplified schematic illustration of a plurality of actuator units arranged within a spiral tube, in accordance with an embodiment. Such a configuration of actuator units may create sensation that spirals up and down an appendage wrapped with the spiral tube. The spiral tube may be provided, for example, with memory wire or other mechanisms to enable the tube to retain its helical shape. Alternatively, the spiral tube may include joints or other mechanisms to enable the user to adjust the tube shape to wrap around appendages of various sizes.

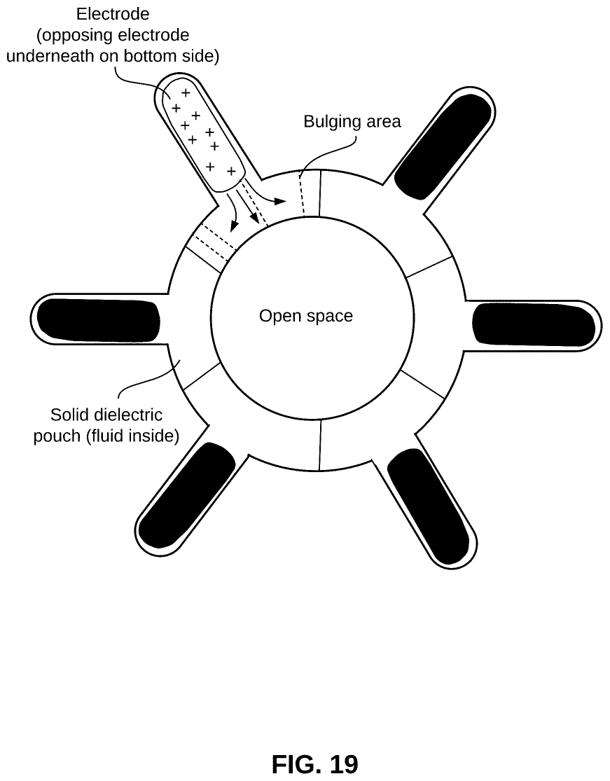

FIG. 19 shows a simplified schematic illustration of an actuator system with a plurality of actuator units arranged in a ring configuration, in accordance with an embodiment. Each one of the finger-like actuator units may be independently addressed or groups of actuator units may be activated together so as to transmit a sensation to an appendage disposed within the open space within the ring configuration. Such a design enables 360-degree sensation around the appendage placed therein.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”—whether explicitly discussed or not—and, conversely, were there only disclosure of the act of “protruding”, such a disclosure should be understood to encompass disclosure of a “protrusion”. Such changes and alternative terms are to be understood to be explicitly included in the description.

1. An actuator system comprising:
a sleeve for accommodating an appendage of a user therein;
a plurality of actuators, each one of the plurality of actuators including
a deformable shell defining a pouch including an enclosed internal cavity,
a fluid dielectric contained within the enclosed internal cavity,
a first electrode disposed over a first side of the pouch, and
a second electrode disposed over a second side of the pouch; and
a power source for providing a voltage across the enclosed internal cavity between the first and second electrodes of the plurality of actuators,
wherein the sleeve includes features for accommodating the plurality of actuators therein,
wherein the features in the sleeve are configured for distributing the plurality of actuators within the sleeve in a predetermined manner,
wherein actuation of the plurality of actuators by application of the voltage produces a plurality of directional forces on the appendage contained within the sleeve.

2. The actuator system of claim 1,
wherein, in each one of the plurality of actuators, the pouch has a length and a width, the length being longer than the width,
wherein, in each one of the plurality of actuators, the first and second electrodes are disposed over the pouch such that, when activated with the voltage applied across the first and second electrodes, the fluid dielectric is displaced in a length direction within the pouch, and
wherein the features in the sleeve are further configured for aligning the plurality of actuators such that the length direction of each one of the plurality of actuators is in alignment with the length direction of each other one of the plurality of actuators.

3. The actuator system of claim 2,
further comprising a controller for controlling the power source,
wherein the power source is configured for individually addressing each one of the plurality of actuators, and
wherein the controller is configured for modulating the power source such that the plurality of actuators are activatable in an activation pattern.

4. The actuator system of claim 3, wherein the activation pattern includes at least one of a peristaltic motion, a wave motion, and a pumping motion.

5. The actuator system of claim 1,
wherein, in each one of the plurality of actuators, the pouch has a length and a width, the length being longer than the width,
wherein, in each one of the plurality of actuators, the first and second electrodes are disposed over the pouch such that, when activated with the voltage applied across the first and second electrodes, the fluid dielectric is displaced in a length direction within the pouch, and
wherein the features in the sleeve are further configured for aligning the plurality of actuators such that the length direction of at least one of the plurality of actuators is not in alignment with the length direction of at least one other one of the plurality of actuators.

6. The actuator system of claim 1, wherein the sleeve formed of a stretchable material such that the sleeve may be stretched without affecting activation of the plurality of actuators.

7. The actuator system of claim 1, further comprising:
a second deformable shell encapsulating at least one of the plurality of actuators; and
an electrically conductive outer layer disposed over at least a portion of the second deformable shell and connected to a ground.

8. An actuator system comprising:
a plurality of actuators, each one of the plurality of actuators including
a deformable shell defining a pouch including an enclosed internal cavity,
a fluid dielectric contained within the enclosed internal cavity,
a first electrode disposed over a first side of the pouch, and
a second electrode disposed over a second side of the pouch;
a power source for providing a voltage across the enclosed internal cavity between the first and second electrodes of the plurality of actuators; and
a controller for controlling the power source,
wherein the controller is configured for monitoring a value of at least one of charge, voltage, capacitance, resistance, and distance between neighboring actuators, and
wherein the controller is further configured for adjusting the voltage provided by the power source according to the value so monitored.

9. The actuator system of claim 8,
wherein the power source is configured for individually addressing each one of the plurality of actuators, and
wherein the controller is further configured for modulating the power source such that the plurality of actuators are activatable in an activation pattern.

10. The actuator system of claim 9, wherein the activation pattern includes at least one of a peristaltic motion, a wave motion, and a pumping motion.
